(19) United States
(12) Patent Application Publication
(10) Pub. No.: US 2011/0289482 A1
(43) Pub. Date: Nov. 24, 2011

(54) PERFORMANCE DETECTION AND DEBUGGING OF APPLICATIONS

(75) Inventor: Jon BENTLEY, New Providence, NJ (US)

(73) Assignee: AVAYA INC., Basking Ridge, NJ (US)

(21) Appl. No.: 12/785,654

(22) Filed: May 24, 2010

(51) Int. Cl. G06F 9/44

(52) U.S. Cl. 717/125; 717/128

(57) ABSTRACT

The system and method establish a baseline of a parameter of an application. The parameter can be based on time spent in a function, out of range variables, memory allocations, memory de-allocations, page faults, time spent in a section of code, time spent in a line of code, and the like. The baseline is done while the application is operating. A threshold for the parameter is generated by the system and/or defined by a user. The system then breaks into a debugger and/or stores state information when the threshold is met.

In a second embodiment, the source code for a function where the break occurred is retrieved and compared to a template that identifies one or more potential coding errors. The template is applied to the source code to identify the potential coding errors. The potential coding errors are then displayed to a user.

### TECHNICAL FIELD

The system and method relates to software performance measurement systems and in particular to software performance measurement debugging systems.

### BACKGROUND

Currently, it is difficult to easily identify performance problems in large software systems. Many times, the performance problems only manifest themselves after the system has been running for a long period of time or when a rarely used code path is executed. Many times, these types of bugs may only manifest themselves based on a specific configuration. There have been attempts to address performance problems in systems. For example, U.S. Pat. No. 7,269,824 discloses a system that monitors an application in real-time to establish a state of health of the application. The problem with this solution and other existing solutions is that they do not provide an inteactive system that can quickly identify what the potential performance problem is. What is needed is a system that will not only monitor in real time for these types of problems, but be able to provide a developer with the information necessary to identify specific areas of code that may be the root cause of the performance problem.

### SUMMARY

The system and method are directed to solving these and other problems and disadvantages of the prior art. The system and method establish a baseline of a parameter of an application. The parameter can be based on time spent in a function, out of range variables, memory allocations, memory de-allocations, page faults, time spent in a section of code, time spent in a line of code, and the like. The baseline is done while the application is operating. A threshold for the parameter is generated by the system and/or defined by a user. The system then breaks into a debugger and/or stores state information when the threshold is met.

In a second embodiment, the source code for a function where the break occurred is retrieved and compared to a template that identifies one or more potential coding errors. The template is applied to the source code to identify the potential coding errors. The potential coding errors are then displayed to a user.

### BRIEF DESCRIPTION OF THE DRAWINGS

These and other features and advantages of the system and method will become more apparent from considering the following description of an illustrative embodiment of the system and method together with the drawing, in which:

FIG. 1 is a block diagram of a first illustrative system for analyzing and debugging an application.

FIG. 2 is a flow diagram of a method for analyzing and debugging an application.

FIG. 3 is a flow diagram of a method of analyzing different parameters to debug an application.

FIG. 4 is a flow diagram of a method of applying a template to source code and displaying potential coding errors to a user.

### DETAILED DESCRIPTION

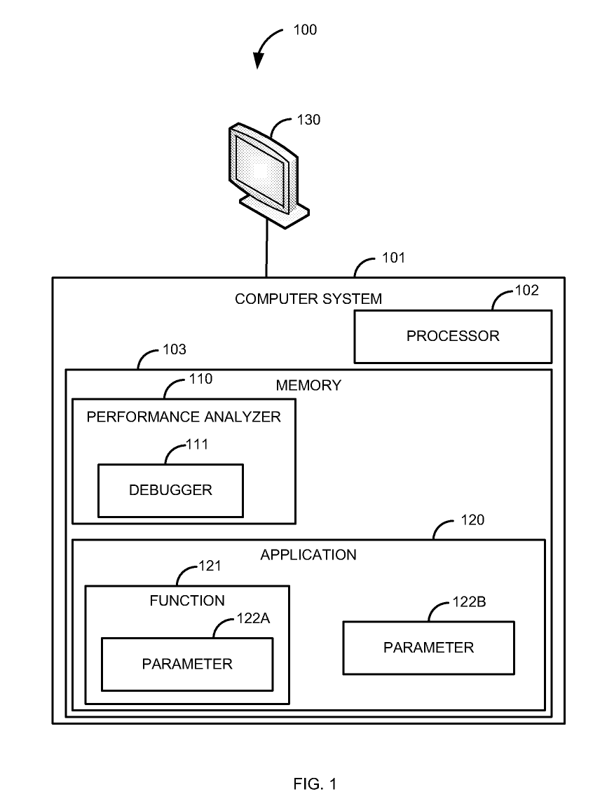

FIG. 1 is a block diagram of a first illustrative system 100 for analyzing and debugging an application 120. The first illustrative system 100 comprises a computer system 101 and a display 130. The display 130 is any type of device that can display information such as a monitor, a personal computer, a television, and the like.

The computer system 101 can be any type of computer system that can run an application 120 such as a personal computer, a server, a plurality of servers, a Private Branch eXchange (PBX), an application server, a network device, a combination of these, and the like. The computer system 101 is shown as a single device. However, the computer system 101 can be one or more devices. The computer system 101 comprises a processor 102, memory 103, a performance analyzer 110, and application 120. The processor 102 can be any type device that can process instructions such as a microprocessor(s), a microcontroller(s), a multi-core processor, a computer(s), and the like.

The memory(s) 103 can be any type of memory such as Random Access Memory (RAM), Read Only Memory (ROM), flash memory, a computer disk, cache memory, a flash drive, a network disk, any combination of these, and the like. The performance analyzer 110 and the application 120 are shown in memory 103. Processor 102 executes performance analyzer 110 and application 120 in memory 103. This can be done using a variety of methods known in the art such as by an operating system, using different threads, using a single thread, and the like.

The performance analyzer 110 is shown in memory 103, but can be stand alone as well. The performance analyzer 110 can be implemented in hardware, firmware, machine code, software, and the like. The performance analyzer 110 also comprises a debugger 111. The debugger 111 is shown as part of the performance analyzer 110, but could be apart from the performance analyzer 110. The debugger 111 allows a user to break at specific points of code in the application to debug application 120.

Application 120 can be any type of application such as a software application, an embedded application, a firmware application, a networked application, multiple applications, distributed applications, and the like. Application 120 is typically compiled based on some type of source code (e.g., C, C++, Java, and the like) that contains functions 121. The debugger 111 is used to define the relationship between the source code and the compiled code of the application 120. Function 121 is an illustrative construct of source code that is used to compile the application 120. The application 120 is typically created based on a software program comprising multiple functions 121. The function 121 can comprise one or more parameters 122. In FIG. 1 the application 120 is shown with parameter 122A within the function 121 and a parameter 122B external to function 121. Parameter 122 can be any type of object/process that is used or is part of application 120. For example, parameter 122 can be a function 121, a variable, an amount of allocated memory, a page fault, a line or section of code, and the like. A parameter 122 can be a local variable or a global variable.

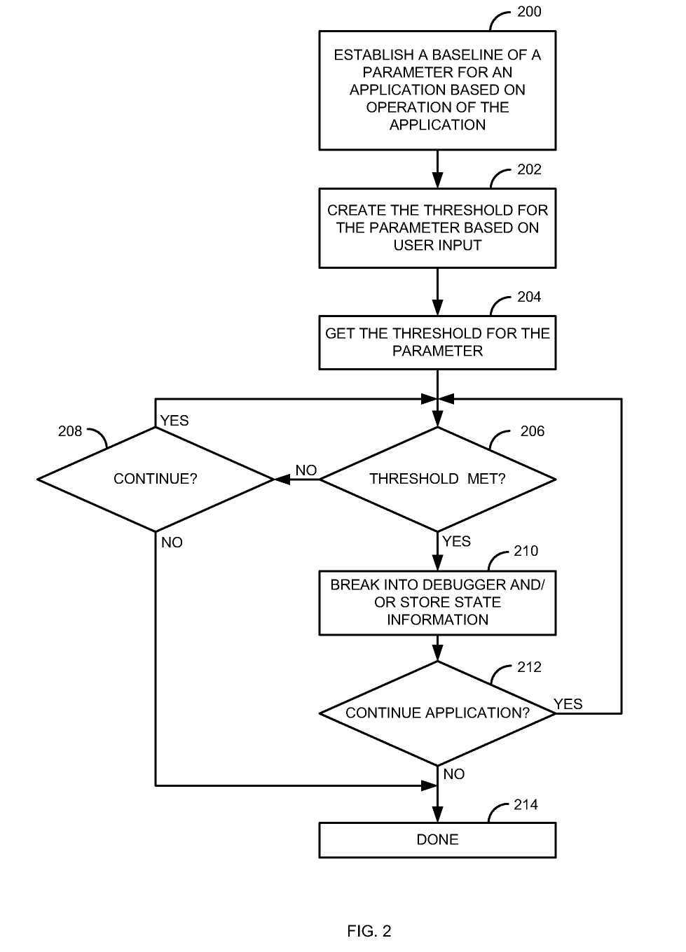

FIG. 2 is a flow diagram of a method for analyzing and debugging an application 120. Illustratively, computer system 101, analyzer 110, debugger 111, application 120, and function 121 are stored-program-controlled entities, such as a computer or processor 102, which performs the method of FIGS. 2-4 and the processes described herein by executing program instructions stored in a tangible computer readable storage medium, such as a memory 103 or disk. As one experienced in the art will easily determine, the methods of FIGS. 2-4 can be implemented a different order and still achieve the desired functionality.

The performance analyzer 110 establishes 200 a baseline of parameter(s) 122 for application 120 based on operation of application 120. This can be for example, running application 120 through a testing process, in a live configuration, under load conditions, and the like. In establishing the baseline for a parameter, performance analyzer 110 creates 202 a threshold for the parameter(s) 122. This can be done automatically. In an alternative, a user can create the threshold for the parameter(s). This can be done based on the automatically created threshold or based on some other reason that may suite the user. The threshold can be any type of threshold that can be used in application 120 such as, but not limited to a time spent in a function, a value of a variable, a range of a variable, an amount of allocated memory, an amount of memory de-allocated, a number of page faults over a time period, a time spent executing a line of code, a time spent executing a section of code, and the like.

The performance analyzer 110 gets 204 the threshold for the parameter 122. The performance analyzer can get the threshold for multiple parameters 112. For example, the performance analyzer 110 can get a threshold for a global variable, a local variable, and a threshold for an amount of allocated memory. The performance analyzer 110 monitors application 120 in step 206 to determine if the threshold is met. If the threshold is not met in step 206, the process goes to step 208. If the user wants to continue in step 208, the process goes back to step 206. Otherwise, if the user does not want to continue in step 208, the process is done 214. If the threshold is met in step 206, performance analyzer 110 can break 210 into the debugger 111 and/or store state information of application 120. State information can be any information that may aid the user in debugging the application 120. For example, state information can include any of the following: a value of a program counter, a value of a variable, a parameter passed to a function 121, a time when the threshold was met, an input file name, usage information, data in memory 103, and the like.

To give an example of how a user may use state information, consider the following example; assume that performance analyzer 110, instead of breaking into the debugger 111 when the threshold is met, just stores off the state information in step 210. The state information is displayed to the user in display 130 and is updated each time the threshold is met. After observing application 120 over an extended period of time, the user notices that the threshold is met at a specific time of day or when a specific configuration is being used. This allows the user to gain better insight into what may be causing the problem. The user can later configure the performance analyzer 110 to break into debugger 111 in step 210 the next time the threshold is met to further debug the problem.

On the other hand, if the process breaks into the debugger 111 in step 210, the user may want to look at variables, what is in memory, how much memory is allocated, the number of page faults that have occurred, time spent in a function, time spent on a line or section of code, and the like in order to identify any potential performance bugs in the software. If the user wants to continue to run the application (or if the user has defined not to break into the debugger 111 in step 210 in step 212, the process goes back step 206. Otherwise, if the user does not want to continue running application 120 in step 212, the process is done 214.

As an illustrative example, assume that application 120 is a communication system that uses packet buffers. The performance analyzer 110 establishes 200 a baseline of a number of packet buffers (parameter 122) for a protocol stack in application 120. This can be established during a baseline test process that determines the number of packet buffers stays between 2 and 4 buffers during operation of application 120. The threshold of 2-4 buffers is created 202 from the baseline and the performance analyzer 110 gets 204 the threshold. The performance analyzer 110 monitors 206 the number of packet buffers to determine that the number of packet buffers remains between 2 and 4. Upon an indication that the number of packet buffers drops to 1 (memory de-allocation) or increases to 5 (memory allocation), the performance analyzer 110 breaks 210 into debugger 111 on the line of code where the memory de-allocation or allocation occurred. The user can look at the code where the number of buffers was either decreased or increased, thus allowing easier debugging of application 120.

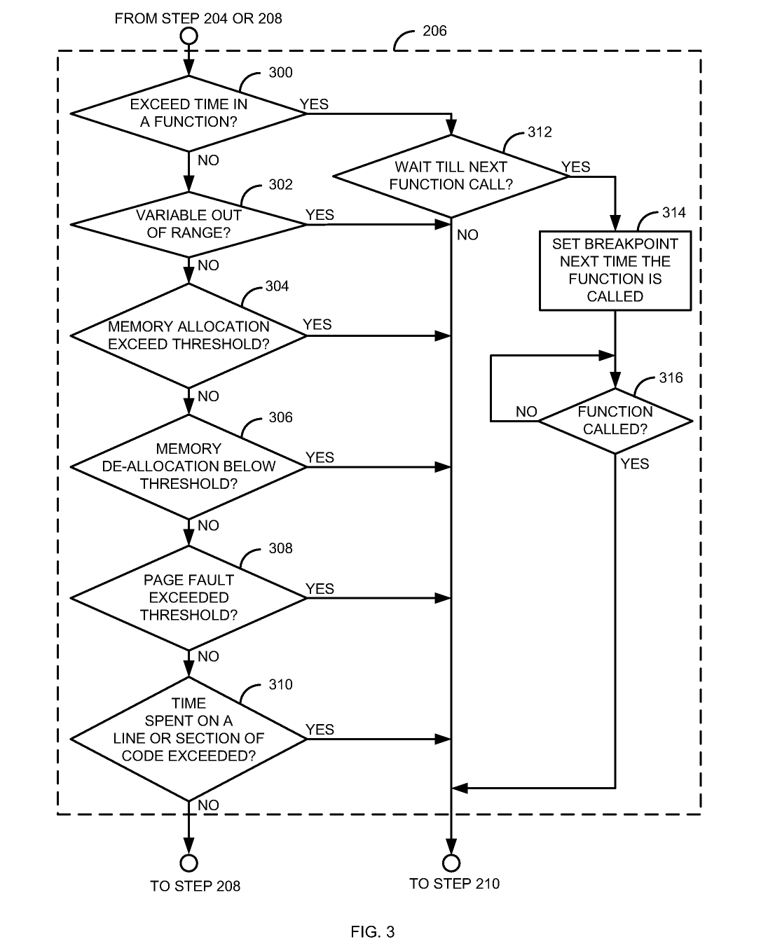

FIG. 3 is a flow diagram of a method of analyzing different parameters 122 to debug application 120. FIG. 3 is an expanded view of an exemplary embodiment of step 206 in FIG. 2. From viewing the process of FIG. 3, it will be obvious to one skilled in the art that the process of FIG. 3 can be organized in various different orders.

The performance analyzer 110 determines if a time in a function 121 has been exceeded in step 300. If the time in the function 121 has been exceeded in step 300, the performance analyzer 110 determines in step 312 if it is to wait till the next time the function 121 is called. If the performance analyzer 110 determines in step 312 that it will not wait till the next time the function 121 is called, the process goes to step 210 where it breaks into the debugger 111. Otherwise, if the performance analyzer 110 determines in step 312 that it will wait till the next time function 121 is called, debugger 111 sets 314 a breakpoint the next time function 121 is called. A reason why performance analyzer 110 may want to set the breakpoint the next time the function 121 is called can be based on performance analyzer 110 determining that the time was exceeded while returning from the function 121 or after returning from the function 121. The debugger then waits 316 until function 121 is called again. The wait process in step 316 can be implemented in various ways such as a thread and the like. When the function 121 is called again, the process goes to step 210 and breaks into debugger 111.

If in step 300, performance analyzer 110 determines that the time spent in the function 121 was not exceeded, performance analyzer 110 determines in step 302 if a variable (parameter 122) is out of range. If the variable is out of range in step 302, the process goes to step 210 and breaks into debugger 111. For example, if the range of a variable is an integer that has a range of between 0 and 100, when the performance analyzer 110 receives an indication that the value of the variable has reached 101, the performance analyzer 110 will break into debugger 111. A variable can be a local variable or a global variable. A variable can be various kinds of programming constructs such as an integer, a long, a short, a float, a boolean, a pointer, an index, and the like.

If performance analyzer 110 in step 302 determines that the variable is not out of range, performance analyzer 110 determines if a memory allocation (parameter 122) has exceeded a threshold (i.e., a memory leak). If the memory allocation has exceeded the threshold in step 304, the process goes to step 210 and breaks into debugger 111. This allows the user to determine the specific code location of where the memory allocation occurred. The memory allocation can be any type of memory allocation such as a malloc, a calloc, creation of an object, creation of an array, creation of a buffer, and the like. The system can also track total memory allocations/de-allocations for the application 120 as part of the baseline.

Otherwise, if performance analyzer 110 in step 304 determines that the memory allocation has not exceeded the threshold, the performance analyzer 110 determines in step 306 if a memory de-allocation (parameter 122) is below a threshold. If the performance analyzer 110 determines that the memory de-allocation is below the threshold, the performance analyzer breaks into the debugger 111.

If performance analyzer 110 in step 306 determines that the memory de-allocation is not below the threshold, performance analyzer 110 determines in step 308 if a page fault threshold (parameter 122) has been exceeded. If the page fault threshold in step 308 has been exceeded, performance analyzer 110 breaks into debugger 111 in step 210. The page fault threshold can be based on a total number of page faults, a number of page faults over a time period, and the like. Otherwise, if the page fault threshold in step 308 has not been exceeded, performance analyzer 110 determines in step 310 if the time spent on a line or section of code has been exceeded. If performance analyzer 110 determines in step 310 that the time spent in a line or section of code has been exceeded (i.e., exceeding the baseline threshold), performance analyzer 110 breaks into debugger 111. Otherwise, if performance analyzer 110 determines in step 310 that the time spent on a line or section of code has not been exceeded, the process goes to step 208.

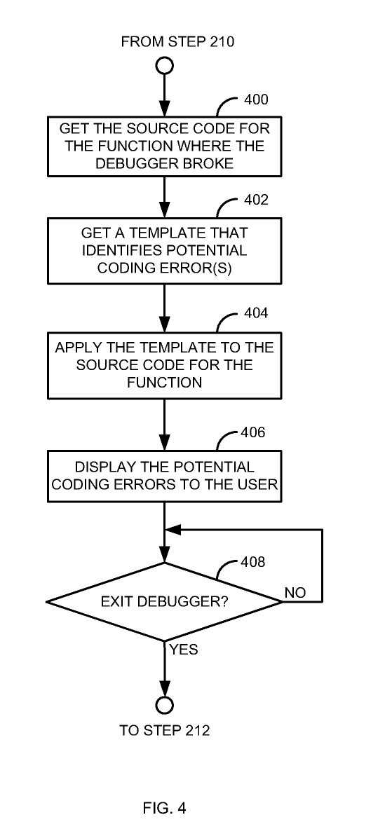

FIG. 4 is a flow diagram of a method of applying a template to source code and displaying potential coding errors to a user via debugger 111. The process of FIG. 4 as shown goes between step 210 and 212 of FIG. 2. Debugger 111 gets 400 the source code for function 121 where the debugger 111 broke. Debugger 111 gets 402 a template that identifies potential coding errors in the source code. For example, the template can include various kinds of potential coding errors such as a missing initialization of a variable, improper initialization of a variable, a failure to increment a counter, a failure to reset a counter, improper use of a library function, improper use of a quick sort, improper use of a hashing function, improper use of a heap sort, an improper use of a logarithm, failure to reset a pointer, failure to initialize a pointer, and the like.

Debugger 111 applies 404 the template to the source code for the function 121. Applying the template to the source code for the function can be done in various ways. For example, the debugger 111 can flag the potential coding errors and list alternative ways to fix the problem. If the user failed to initialize a variable, the debugger 111 can flag that the variable was not initialized and suggest to the user to add code to initialize the variable. Another example is where the debugger 111 can look at a pointer to determine if the pointer is pointing to a different structure or array in memory 103 than the object initially assigned to the pointer; the debugger can flag this to the user and make a suggestion to write code to re-initialize the pointer. Debugger 111 could suggest specific areas in the source code to do this. The potential coding error can be any one of a variety of errors, such as, a global variable is not being initialized in function 121, a local variable is not being initialized in function 121, a memory allocation is being handled differently at different return points in function 121, a variable is not being incremented properly, the variable is not being reinitialized, an improper if def mode, an inefficient sorting routine, a failure to reset a pointer, a failure to initialize a pointer, an inefficient hashing algorithm, and the like. The potential coding errors are then displayed 406 to the user in display 130. Debugger 111 then waits in step 408 until the user wants to exit debugger 111. When the user wants to exit debugger 111, the process then goes to step 212.

In this document, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this document, the term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method implemented by a processor comprising:
a. establishing a baseline of a parameter for an application, wherein the baseline of the parameter is established based on operation of the application;
b. getting a threshold for the parameter, wherein the threshold is based on the baseline; and
c. doing at least one of the following:
i. breaking into a debugger when the threshold is met; and/or
ii. storing state information of the application when the threshold is met.

2. The method of claim 1, wherein the threshold is created based on user input and/or automatically.

3. The method of claim 1, wherein the parameter is a function within the application, wherein the threshold is a time spent in the function, wherein the threshold is met before a return from the function, and wherein breaking into the debugger occurs before the return from the function.

4. The method of claim 1, wherein the parameter is a function within the application, wherein the threshold is a time spent in the function, wherein the threshold is met after or during a return from the function, and wherein breaking into the debugger occurs the next time the function is called.

5. The method of claim 1, wherein the parameter is a variable within the application, wherein the threshold is a range of the variable, and wherein the threshold is met based on a value of the variable going outside the range of the variable.

6. The method of claim 1, wherein the parameter is an amount of allocated memory, wherein the threshold is exceeding the amount of allocated memory, and wherein the threshold is met based on detecting a memory allocation that exceeds the threshold.

7. The method of claim 1, wherein the parameter is an amount of allocated memory, wherein the threshold is going below the amount of allocated memory, and wherein the threshold is met based on detecting a memory de-allocation that falls below the threshold.

8. The method of claim 1, wherein the parameter is a page fault, wherein the threshold is going over a number of page faults, and wherein the threshold is met based on detecting the number of page faults over the time period.

9. The method of claim 1, wherein breaking into the debugger comprises breaking in a function within the application and further comprising:
d. getting source code for the function;
e. getting a template that identifies one or more potential coding errors;
f. applying the template to the source code for the function to identify the one or more potential coding errors; and
g. displaying the potential coding errors to a user.

10. The method of claim 9, wherein the one or more potential coding errors is at least one of the following: a global variable is not being initialized in the function, a local variable is not being initialized in the function, a memory allocation is being handled differently at different return points in the function, a variable is not being incremented properly, the variable is not being reinitialized, an improper if def mode, an inefficient sorting routine, failure to reset a pointer, failure to initialize a pointer, and an inefficient hashing algorithm.

11. The method of claim 1, wherein the parameter is a line of code or a section of code, wherein the threshold is a time spent in the line of code or the section of code, and wherein the threshold is met based on detecting that the time spent on the line of code or the section of code was exceeded.

12. The method of claim 1, wherein the state information of the application comprises at least one of the following: storing a value of a program counter, storing a value of a variable, storing a parameter passed to a function, storing a time when the threshold was met, storing input file names, storing usage information, and storing data in memory.

13. A computer readable medium having stored thereon instructions that cause a processor to execute a method, the method comprising:
a. instructions to establish a baseline of a parameter for an application, wherein the baseline of the parameter is established based on operation of the application;
b. instructions to get a threshold for the parameter, wherein the threshold is based on the baseline; and
c. instructions to do at least one of the following:
i. break into a debugger when the threshold is met; and/or
ii. store state information of the application when the threshold is met.

14. The method of claim 13, wherein the threshold is created based on user input and/or automatically.

15. The method of claim 13, wherein the parameter is a function within the application, wherein the threshold is a time spent in the function, wherein the threshold is met before a return from the function, and wherein breaking into the debugger occurs before the return from the function.

16. The method of claim 13, wherein the parameter is a function within the application, wherein the threshold is a time spent in the function, wherein the threshold is met after or during a return from the function, and wherein breaking into the debugger occurs the next time the function is called.

17. The method of claim 13, wherein the parameter is a variable within the application, wherein the threshold is a range of the variable, and wherein the threshold is met based on a value of the variable going outside the range of the variable.

18. The method of claim 13, wherein the parameter is an amount of allocated memory, wherein the threshold is exceeding the amount of allocated memory, and wherein the threshold is met based on detecting a memory allocation that exceeds the threshold.

19. The method of claim 13, wherein the parameter is an amount of allocated memory, wherein the threshold is going below the amount of allocated memory, and wherein the threshold is met based on detecting a memory de-allocation that falls below the threshold.

20. The method of claim 13, wherein the parameter is a page fault, wherein the threshold is going over a number of page faults, and wherein the threshold is met based on detecting the number of page faults over the time period.

21. The method of claim 13, wherein breaking into the debugger comprises breaking in a function within the application and further comprising:
d. instructions to get source code for the function;
e. instructions to get a template that identifies one or more potential coding errors;
f. instructions to apply the template to the source code for the function to identify the one or more potential coding errors; and
g. instructions to display the potential coding errors to a user.

22. The method of claim 21, wherein the one or more potential coding errors is at least one of the following: a global variable is not being initialized in the function, a local variable is not being initialized in the function, a memory allocation is being handled differently at different return points in the function, a variable is not being incremented properly, the variable is not being reinitialized, an improper if def mode, an inefficient sorting routine, failure to reset a pointer, failure to initialize a pointer, and an inefficient hashing algorithm.

23. The method of claim 13, wherein the parameter a time spent on a line or section of code over a time period, and wherein the indication that the threshold will be met is based on detecting that the time spent in the line or the section of code was exceeded.

24. The method of claim 13, wherein the state information of the application comprises at least one of the following: storing a value of a program counter, storing a value of a variable, storing a parameter passed to a function, storing a time when the threshold was met, storing input file names, storing usage information, and storing data in memory.

25. A computer system comprising:
a. a performance analyzer configured to establish a baseline of a parameter for an application, wherein the baseline is established based on operation of the application and get a threshold for the parameter, wherein the threshold is based on the baseline; and
b. a debugger configured to break when the threshold is met and/or store state information of the application when the threshold is met.
